(19) United States
(12) Patent Application Publication
(10) Pub. No.: US 2025/0048034 A1
(43) Pub. Date: Feb. 6, 2025

(54) Acoustic Unit for a Sound Transducer Unit

(71) Applicant: USOUND GMBH, Graz (AT)

(72) Inventors: Andrea Rusconi Clerici Beltrami, Wien (AT); Ferruccio Bottoni, Graz (AT); Jakob Spoetl, Wien (AT); Christian Novotny, Wien (AT); Samu Bence Horváth, Wien (AT)

(21) Appl. No.: 18/790,085

(22) Filed: Jul. 31, 2024

(30) Foreign Application Priority Data
Aug. 1, 2023 (DE) 10 2023 120 424.6

(51) Int. Cl. H04R 9/02; H04R 9/06

(52) U.S. Cl. CPC H04R 9/025; H04R 9/06

(57) ABSTRACT

In one aspect, an acoustic unit for a sound transducer unit for generating and/or detecting sound waves includes a diaphragm and a coil arrangement coupled to the diaphragm. The coil arrangement includes at least one electrical conductor, wherein the at least one electrical conductor has conductor sections at least in a first conductor layer and a second conductor layer of the at least one electrical conductor. The first and the second conductor layers are arranged one above the other. Additionally, at least one conductor section of the first conductor layer shares an overlap portion with at least one conductor section of the second conductor layer in which the at least one conductor sections of the first and second conductor layers overlap.

### CROSS-REFERENCE TO RELATED APPLICATIONS

The present application is based upon and claims the right of priority to German Patent Application No. 10 2023 120 424.6, filed Aug. 1, 2023, the disclosure of which is hereby incorporated by reference herein in its entirety for all purposes.

### FIELD OF THE INVENTION

The present subject matter relates to an acoustic unit for a sound transducer unit, in particular for a flat panel speaker, preferably for a magnetostatic loudspeaker, for generating and/or detecting sound waves, the acoustic unit having a diaphragm and having a coil arrangement which is coupled to the diaphragm, the coil arrangement having at least one electrical conductor, wherein the at least one electrical conductor has conductor sections at least in a first conductor layer and a second conductor layer, and wherein the first and the second conductor layers are arranged one above the other.

### BACKGROUND OF THE INVENTION

JP 2000-345369 A discloses an acoustic unit having a coil arrangement.

Generally, a need exists to provide an acoustic unit having a coil arrangement for a sound transducer unit, with which greater electromagnetic forces can be made possible.

### SUMMARY OF THE INVENTION

In various aspects, the present subject matter, is directed to an acoustic unit, a sound transducer unit, a coil arrangement, and the use of a coil arrangement and the acoustic unit having the features described and claimed herein.

In one aspect, the present subject matter relates to an acoustic unit for a sound transducer unit, in particular for a flat panel speaker, preferably for a magnetostatic loudspeaker, for generating and/or detecting sound waves.

The acoustic unit has a diaphragm. The diaphragm can be deflected in order to generate the sound waves. Additionally or alternatively, the diaphragm can also be deflected by the sound waves, allowing the diaphragm to detect the sound waves.

Moreover, the acoustic unit has a coil arrangement which is coupled to the diaphragm, the coil arrangement having at least one electrical conductor. The at least one electrical conductor has conductor sections at least in a first conductor layer and in a second conductor layer. The electrical conductor can be acted upon by an electrical signal which forms an electric current in the electrical conductor. When the acoustic unit is arranged in a permanent magnetic field of the sound transducer unit, a deflection of the diaphragm results due to the Lorentz force and the sound waves are generated according to the electrical signal. By comparison, if the diaphragm is deflected by incoming sound waves, the electrical conductor moves in the permanent magnetic field and a voltage, or the electrical signal, is induced. As a result, the sound waves can be detected.

Furthermore, the first and the second conductor layers are arranged one above the other.

In addition, at least some conductor sections of different conductor layers share an overlap section in which the conductor sections of the different conductor layers overlap.

It is also advantageous when the at least one electrical conductor is arranged in the at least two conductor layers such that, in the conductor sections that overlap in a common overlap section, the electric currents are oriented in parallel with one another and/or in the same direction. This results in a higher Lorentz force. As a result, when the sound waves are generated, the deflection can be amplified.

An advantage results when the conductor sections in the overlap sections and/or the conductor layers are arranged one above the other in a normal direction of the coil arrangement and/or of the acoustic unit.

It is advantageous when the conductor sections overlap in transverse directions and/or in the longitudinal direction of the coil arrangement. Additionally or alternatively, it is useful when the overlap sections extend in transverse directions and/or in the longitudinal direction of the coil arrangement.

It is useful when the conductor sections are straight and/or curved, in particular circular.

It is useful when multiple, in particular at least two, preferably at least four, particularly preferably fewer than 20 or fewer than 30 conductor sections arranged in a conductor layer together form a conductor section group, the conductor layers preferably having multiple conductor section groups. As a result, the electric current can flow in the conductor layers in a planar manner. Consequently, the diaphragm can be deflected in a planar manner. A conductor section group can therefore have between two and 20 or 30 conductor sections which are arranged next to one another and, preferably, in parallel with one another.

It is advantageous when a conductor section spacing and/or a conductor group spacing between two adjacent conductor sections and/or conductor section groups is less than 1 mm. Additionally or alternatively, it is advantageous when the conductor section spacing and/or the conductor group spacing is equal to or less than, in particular between 5% and 75% less than, a magnet element width of a magnet element of the sound transducer unit.

Additionally or alternatively, the conductor section spacing and/or the conductor group spacing can also correspond to between 25% and 75% or 90% of the magnet element width. When the acoustic unit is arranged as intended in the sound transducer unit, or between two magnet units which are arranged one above the other, the region between two adjacent conductor sections and/or conductor section groups can be arranged under, or over, a magnet element. In the region under, or over, a magnet element, the magnetic field which has formed is weakest or even disappears, and therefore the conductor sections and/or conductor section groups are barely effective in these regions.

It is advantageous when a conductor section width of the conductor sections and/or a conductor group width of the conductor section groups in the transverse direction is equal to or greater than, in particular 5%, 10%, 15%, 20%, 25%, 30%, 35%, 40%, 45% or 50% greater than, an intended magnet element spacing and/or a width of an open area in the transverse direction between two magnet elements that are arranged directly consecutively in the transverse direction. As a result, the conductor sections and/or the conductor section groups project, at least in some areas, in the transverse direction into the region of the magnet elements. Consequently, the conductor sections and/or the conductor section groups and the magnet elements share portions of overlap between a conductor and a magnet element. As a result, the effectiveness of the deflection can be increased.

It is useful when the at least one electrical conductor is arranged such that the conductor sections are arranged in series to one another. As a result, the electric current is conducted through the conductor sections one by one.

It is advantageous when the at least one electrical conductor is arranged such that the electric current flowing therein is conductable, in particular multiple times, alternatingly in the first and in the second conductor layers.

An advantage results when multiple conductor sections and/or conductor section groups are adjacently arranged in the at least first and/or second conductor layer(s), in particular in the transverse direction, and when the electrical conductor is arranged such that a current direction is alternatingly oriented in opposite directions in these adjacently arranged conductor sections and/or conductor section groups. As a result, the Lorentz forces, which act on the conductor sections and/or conductor section groups, can be identically oriented in each case.

It is advantageous when the electrical conductor is arranged in a meandering manner. As a result, the electric current can be conducted alternatingly in opposite directions through the electrical conductors.

An improvement results when between two and ten or 20, in particular four, overlap sections are adjacently arranged in the transverse direction of the coil arrangement.

It is useful when the electrical conductor is arranged such that the electric currents flowing in the conductor sections of a conductor section group are oriented in parallel with one another and/or in the same direction.

An improvement results when the electrical conductor is arranged such that the electric currents of the conductor sections of two adjacent, in particular directly adjacent, conductor section groups are oriented antiparallel to each other and/or in opposite directions. As a result, the Lorentz forces are identically oriented.

It is useful when the at least one electrical conductor has connecting sections which electrically connect the conductor sections of a conductor layer to one another.

An advantage results when the at least one electrical conductor has contacting sections which electrically connect the conductor sections of different conductor layers to one another.

It is advantageous when the connecting sections have mirror symmetry at a mirror line, so that a connecting section of one conductor layer is mirrored onto a connecting section of the other conductor layer. The connecting sections are therefore arranged, formed and/or installed such that they have this mirror symmetry at the mirror line. In this mirror symmetry at the mirror line, the current direction, when mirrored, reverses in the mirrored connecting sections. As a result, an advantageous and space-saving arrangement of the electrical conductor is achieved. Moreover, as a result, the situation is easily achieved in which the electric currents in the conductor sections which share an overlap section are oriented in parallel with one another and/or in the same direction and/or identically. This mirror symmetry applies, of course, only for the connecting sections that have a mirror partner.

Moreover, it is advantageous when the connecting sections cross over intermediate regions of the conductor sections and/or of the conductor section groups. The intermediate regions are arranged between each of two adjacent conductor sections and the next. Additionally or alternatively, the intermediate regions can also be arranged between each of two adjacent conductor section groups and the next. Additionally or alternatively, it is advantageous when the connecting sections cross over magnet elements of a magnet unit of the sound transducer unit when the acoustic unit is arranged in the sound transducer unit as intended. As a result, a disturbing influence of the electric current in the regions outside the conductor sections is reduced.

Moreover, it is advantageous when the connecting sections are arranged in a longitudinal direction of the magnet elements in regions outside the magnet elements. In the region outside of or next to the magnet elements, the permanent magnetic field of the magnet elements weakens, and therefore the electric current in the connecting sections only weakly interacts with the permanent magnetic field. The connecting sections therefore project beyond the respective ends of the magnet elements.

An improvement results when the electrical conductor is printed using a 3D printing process. As a result, the acoustic unit can be formed in an easy way.

Moreover, it is advantageous when the acoustic unit, in particular the coil arrangement, is produced by means of a lithography process for semiconductor technology. As a result, the coil arrangement can be produced with very small structures and with very low tolerance. The coil arrangement can also be arranged on the, in particular flexible, diaphragm, and/or can be connected thereto. For example, the coil arrangement can be adhesively bonded onto the diaphragm.

It is advantageous when the coil arrangement is resistant to deformation. As a result, the coil arrangement is deflected as a unit and is not deformed, and therefore the electric currents are conducted and remain between the magnet elements in a targeted manner and with low tolerance. Deformations of the coil arrangement could result in the electric currents being conducted where they are not to be conducted and/or could result in acoustically disadvantageous forms of movement of the diaphragm and/or of the acoustic units.

It is also advantageous when the coil arrangement and/or at least one of the two conductor layers, in particular both conductor layers, are made of a silicon substrate. The electrical conductor can be introduced into the conductor layers. As a result, the manufacturing process by means of semiconductor technology is associated with the resistance to deformation. The coil arrangement can have, for example, a thickness of 50 μm.

It is advantageous when the diaphragm is flexible. Consequently, the diaphragm can deflect and the coil arrangement remains rigid and/or resistant to deformation.

According to one advantageous enhanced embodiment of the present subject matter, it is useful when the coil arrangement is connected to the diaphragm and/or when the electrical conductor is formed with the diaphragm, in particular being printed into a diaphragm material.

It is advantageous when the coil arrangement, in particular the electrical conductor, is embedded into the diaphragm and/or is surrounded by the diaphragm material. As a result, a fixed connection can be formed between the coil arrangement, or the electrical conductor, and the diaphragm.

It is useful when an insulating layer is arranged between the conductor layers. As a result, the electric current can be conducted through the conductor sections as intended.

It is advantageous when the acoustic unit has a first protective layer and/or a second protective layer. As a result, the electrical conductor can be protected, for example, against oxidation.

The present subject matter also relates to a sound transducer unit, in particular a flat panel speaker, preferably a magnetostatic loudspeaker, for generating and/or detecting sound waves.

The sound transducer unit has at least one magnet unit, which includes multiple magnet elements. A permanent magnetic field can be formed by means of the at least one magnet unit. Preferably, the sound transducer unit has at least two magnet units, each of which preferably includes multiple magnet elements.

The sound transducer unit has at least one acoustic unit, the acoustic unit being designed according to one or more features of the preceding description and/or the following description. The acoustic unit is advantageously arranged in the permanent magnetic field of the at least one magnet unit. The acoustic unit includes the at least one electrical conductor which can be acted upon by an electric current. If the electric current flows through the electrical conductor, the Lorentz force is formed in the permanent magnetic field, and therefore the diaphragm is deflected and the sound waves are generated. By comparison, if the diaphragm is deflected together with the electrical conductor, a voltage is induced. As a result, the sound waves can be detected.

The present subject matter also relates to a coil arrangement for an acoustic unit and/or for a sound transducer unit having at least one feature of the preceding description and/or the following description.

The present subject matter also relates to a use of a coil arrangement which has, in particular, at least one feature and a feature of the preceding description and/or the following description relating to the coil arrangement. The coil arrangement is designed for an acoustic unit according to one or more features of the preceding description and/or the following description.

The acoustic unit is designed according to the preceding description, wherein the mentioned features can be present individually or in any combination.

The present subject matter also relates to a use of an acoustic unit, which has at least one feature of the preceding description and/or the following description, for a coil arrangement and/or a sound transducer unit, which are designed according to one or more of the features mentioned in the preceding description and/or the following description.

### BRIEF DESCRIPTION OF THE FIGURES

Further advantages of the invention are described in the following exemplary embodiments, wherein:

FIG. 1 shows a lateral cross-section through a schematic view of a sound transducer unit having two magnet units and one acoustic unit,

FIG. 2 shows a lateral cross-section through a schematic view of an acoustic unit having two conductor layers and one electrical conductor,

FIG. 3 shows a top view of a schematic view of an acoustic unit having an electrical conductor,

FIG. 4 shows a perspective view of an electrical conductor in two conductor layers and with multiple conductor sections,

FIG. 5a shows a top view of a circular electrical conductor in a first conductor layer,

FIG. 5b shows a top view of a circular electrical conductor in a second conductor layer,

FIG. 6a shows a sectional view along the cutting plane A-A from FIG. 3,

FIG. 6b shows a sectional view along the cutting plane B-B from FIG. 3, and

FIG. 7 shows FIG. 4 with only a portion of the reference characters included and with the mirror line.

### DETAILED DESCRIPTION

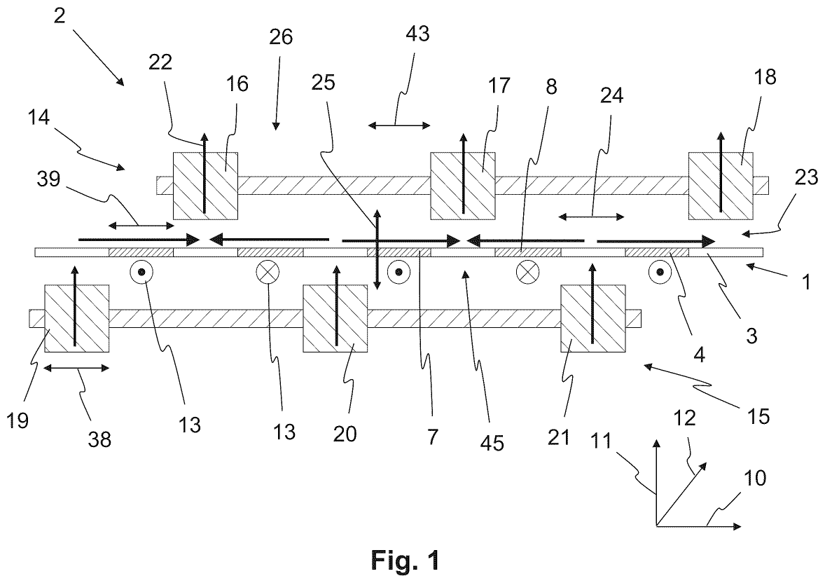

FIG. 1 shows a lateral cross-section through a schematic view of a sound transducer unit 2 having two magnet units 14, 15 and one acoustic unit 1. The acoustic unit 1 also has a diaphragm 3 and a coil arrangement 4. By means of the sound transducer unit 2, sound waves can be generated and/or detected. The sound transducer unit 2 can be, for example, a flat panel speaker or, preferably, a magnetostatic loudspeaker. By means of the acoustic unit 1, or the sound transducer unit 2, sound waves can be generated and/or detected.

By means of the two magnet units 14, 15 shown here, a permanent magnetic field 23 can be formed, which acts on the acoustic unit 1. Moreover, the acoustic unit 1 is arranged in the permanent magnetic field 23. The acoustic unit 1 is also arranged, according to the present exemplary embodiment, between the two magnet units 14, 15.

The magnet units 14, 15 also each include, according to the present exemplary embodiment, multiple magnet elements 16-21. These magnet elements 16-21 each have a magnetizing direction 22, so that the permanent magnetic field 23 is formed. For the sake of clarity, only one magnetizing direction 22 is provided with a reference character. Since the first magnet unit 14 is arranged over the acoustic unit 1 and the second magnet unit 15 is arranged under the acoustic unit 1, the three magnet elements 16-18 are also arranged over the acoustic unit 1 and the three magnet elements 19-21 are also arranged under the acoustic unit 1. The acoustic unit 1 is arranged between the magnet elements 16-21.

Moreover, as is apparent here, the two magnet units 14, 15 are mutually offset such that the magnet elements 16-21 of one magnet unit 14, 15 are arranged between the magnet elements 16-21 of the other magnet unit 14, 15. Moreover, as is apparent here, an open area 26 can be arranged between a magnet element 16-21 of one magnet unit 14, 15 and the magnet element 16-21 of the other magnet unit 14, 15 adjacent thereto in the transverse direction 10. For the sake of clarity, only one open area 26 is provided with a reference character.

The coil arrangement 4 furthermore has at least one electrical conductor 7, to which an electrical signal can be supplied. As a result, an electric current 13 can be formed in the electrical conductor 7. The electric current 13 is also shown here. Due to the electric current 13 in the permanent magnetic field 23, the Lorentz force is formed, and therefore the acoustic unit 1 and, consequently, the diaphragm 3, are deflected along a stroke axis 25. As a result, sound can be generated, and therefore the sound transducer unit 2 is operated as a loudspeaker. By comparison, if the diaphragm 3 is deflected along the stroke axis 25 due to incoming sound, a voltage is induced in the electrical conductor 7, which can be measured. As a result, the sound waves can be detected, so that the sound transducer unit 2 is operated as a microphone.

Moreover, the electrical conductor 7 has at least one conductor section 8. The electrical conductor 7 of the present exemplary embodiment has multiple conductor sections 8. Only one conductor section 8 is provided with a reference character. The conductor sections 8 are preferably arranged in the sound transducer unit 2 in the regions of the open areas 26. In the region of the open areas 26, the permanent magnetic field 23 is most advantageously formed for the deflection of the diaphragm 3. In the transverse direction 10 of the acoustic unit 1, or of the sound transducer unit 2, the conductor sections 8 are preferably arranged next to the magnet elements 16-21 and/or between the magnet elements 16-21. In the conductor sections 8, the electric current 13 can flow in the permanent magnetic field 23 and preferably perpendicularly to the permanent magnetic field 23.

Furthermore, a normal direction 11 is shown here, which is oriented in parallel with the stroke axis 25. A longitudinal direction 12 is also shown. The conductor sections 8 are advantageously oriented in the longitudinal direction 12. Furthermore, the above-described transverse direction 10 is also shown.

FIG. 1 also shows a magnet element spacing 43 between two magnet elements 16-21 which are arranged consecutively in the transverse direction 10. The magnet element spacing 43 is defined, as is apparent, between two magnet elements 16-21 which are arranged consecutively in the transverse direction 10 and are arranged in different magnet units 14, 15.

Moreover, the conductor sections 8 have a conductor section width 39. For the sake of simplicity, only one conductor section 8 is labeled with a conductor section width 39. The conductor section width 39 according to the present exemplary embodiment is such that this adjoins the adjacent magnet elements 16, 19 laterally, or in the transverse direction 10. The conductor section width 39 according to the present exemplary embodiment is as great as the magnet element spacing 43 between two magnet elements 16-21 which are directly adjacent to one another in the transverse direction 10. These two magnet elements 16-21, which are directly adjacent to one another in the transverse direction 10, are also arranged in two different magnet units 14, 15. Additionally or alternatively, the conductor section width 39 can also be greater, for example, between 5% and 50% greater, than the magnet element spacing 43 between two magnet elements 16-21 which are directly adjacent to one another in the transverse direction 10. Consequently, the conductor sections 8 project in the transverse direction 10 into the region of the magnet elements 16-21. The conductor sections 8 and the magnet elements 16-21 therefore share a portion of overlap between a conductor and a magnet element. As a result, the effectiveness of the deflection of the acoustic unit 1, or of the diaphragm 3, can be improved. Additionally or alternatively, the conductor section width 39 can be greater, for example, 5% to 50% greater, than a width of the open area 26.

Moreover, as is apparent here, the acoustic unit 1 is arranged between the two magnet units 14, 15, which are arranged one above the other, such that an intermediate region 45 is arranged between the conductor sections 8 and/or conductor section groups 33 (which are explained below) in the normal direction 11 over and/or under the associated magnet elements 16-21. In this region over, or under, the magnet elements 16-21, the magnetic field 23 is weak or disappears, and therefore the conductor sections 8 and/or the conductor section group 33 are/is only barely effective there. For the sake of clarity, only one intermediate region 45 is provided with a reference character. The acoustic unit 1 can have multiple intermediate regions 45. The intermediate regions 45 extend in the transverse direction 10 and/or in the longitudinal direction 12. The intermediate regions 45 can be designed such that the conductor sections 8 are arranged next to one another and/or in parallel with one another in the transverse direction 10. The intermediate regions 45 are arranged between each of two adjacent conductor sections 8 and the next.

Features that have already been described with reference to the at least one preceding figure are not explained once more, for the sake of simplicity. Furthermore, features can also be first described in this figure or in at least one of the following figures. Moreover, identical reference characters are used for identical features, for the sake of simplicity. In addition, not all features may be shown and/or provided with a reference character in the following figures, for the sake of clarity. Features shown in one or several of the preceding figures can also be present in this figure or in one or more of the following figures, however. Furthermore, for the sake of clarity, features can also be first shown and/or provided with a reference character in this figure or in one or more of the following figures. Nevertheless, features that are first shown in one or more of the following figures can also be already present in this figure or in a preceding figure.

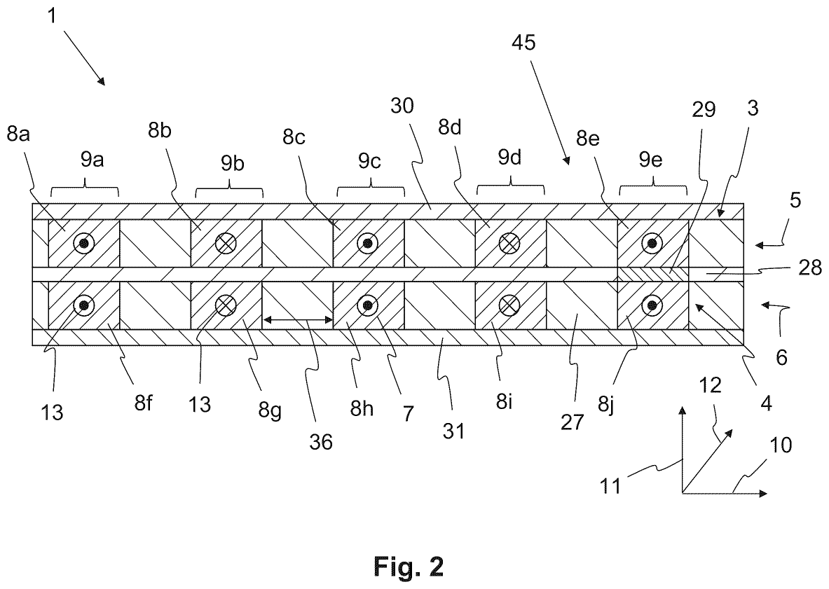

FIG. 2 shows a lateral cross-section through a schematic view of an acoustic unit 1 having two conductor layers 5, 6, the electrical conductor 7 and multiple conductor sections 8a-8j.

Multiple conductor sections 8a-8j are shown in FIG. 2. The electrical conductor 7 includes the multiple conductor sections 8a-8j. The conductor sections 8a-8j extend in the longitudinal direction 12 and/or are spaced apart from one another in the transverse direction 10. The electric current 13 can flow in each conductor section 8a-8j.

Moreover, the acoustic unit 1 has at least two conductor layers 5, 6 which are arranged one above the other, in particular, in the normal direction 11. The conductor sections 8a-8j are arranged in each of the at least two conductor layers 5, 6. In this exemplary embodiment, the first, the second, the third, the fourth and the fifth conductor sections 8a-8e are arranged in the first conductor layer 5. The sixth, the seventh, the eighth, the ninth and the tenth conductor sections 8f-8j are arranged in the second conductor layer 6.

In addition, at least some conductor sections 8a-8j of different conductor layers 5, 6 share an overlap section 9a-9e, in which conductor sections 8a-8j of the different conductor layers 5, 6 overlap. In the overlap sections 9a9e, at least two conductor sections 8a-8j, namely, in particular, one conductor section 8a-8j from each conductor layer 5, 6, overlap.

In the exemplary embodiment shown in FIG. 2, the first and the sixth conductor sections 8a, 8f overlap and share the first overlap section 9a. Furthermore, in the exemplary embodiment shown in FIG. 2, the second and the seventh conductor sections 8b, 8g overlap and share the second overlap section 9b. The third and the eighth conductor sections 8c, 8h overlap and share the third overlap section 9c. The fourth and the ninth conductor sections 8d, 8i overlap and share the fourth overlap section 9d. The fifth and the tenth conductor sections 8e, 8j overlap and share the fifth overlap section 9e.

The overlap sections 9a-9e are arranged, or formed, between the corresponding conductor sections 8a-8j. In the corresponding overlap sections 9a-9e, the corresponding conductor sections 8a-8j are spaced apart from one another in the normal direction 11, which is oriented in parallel with the stroke axis 25. The overlap sections 9a-9e also extend in the transverse direction and in the longitudinal direction 12 and are arranged in these two directions 10, 12 between the corresponding conductor sections 8a-8j which are arranged one above the other.

Moreover, the electric currents 13 are shown in the conductor sections 8a-8j. For the sake of clarity, not all electric currents 13 in the conductor sections 8a-8j are provided with a reference character.

As is also apparent here, in the first and the sixth conductor sections 8a, 8f, which have the common first overlap section 9a, the electric currents 13 are parallel to one another and flow out of the plane of the drawing in this view. In the second and the seventh conductor sections 8b, 8g, which have the common second overlap section 9b, the electric currents 13 are parallel to one another and flow into the plane of the drawing in this view. In the third and the eighth conductor sections 8c, 8h, which have the common third overlap section 9c, the electric currents 13 are parallel to one another and flow out of the plane of the drawing in this view. In the fourth and the ninth conductor sections 8d, 8i, which have the common fourth overlap section 9d, the electric currents 13 are parallel to one another and flow into the plane of the drawing in this view. In the fifth and the tenth conductor sections 8e, 8j, which have the common fifth overlap section 9e, the electric currents 13 are parallel to one another and flow out of the plane of the drawing in this view.

It is therefore advantageous when, in the conductor sections 8a-8j which have a common overlap section 9a-9e, the electric currents 13 are parallel to one another in the corresponding conductor sections 8a-8j. Moreover, it is advantageous when, in the conductor sections 8a-8j, the overlap sections 9a-9e of which are arranged, in particular directly, next to one another in the transverse direction 10, the electric currents 13 flowing therein are oriented opposite to one another. This means, the electric currents 13 in the conductor sections 8a-8j, the overlap sections 9a-9e of which are arranged next to one another, in particular directly next to one another and preferably in the transverse direction 10, alternate in one direction and in the direction opposite thereto. The electric currents 13, as shown in FIG. 2, flow out of the plane of the drawing in the conductor sections 8a-8j in one overlap section 9a-9e and flow into the plane of the drawing in the conductor sections 8a-8j of the overlap section 9a-9e which follows in the transverse direction 10.

Furthermore, the diaphragm 3 of the acoustic unit 1 is shown here. Due to the Lorentz force acting on the electrical conductor 7 in the permanent magnetic field 23, the diaphragm 3 is also deflected. The diaphragm 3 can have a diaphragm material 27. The electrical conductor 7 having the conductor sections 8a-8j is coupled to the diaphragm 3. For example, the electrical conductor 7 can be adhered to the diaphragm 3, or to the diaphragm material 27.

It is particularly advantageous when the electrical conductor 7 is printed onto the diaphragm 3, or the diaphragm material 27, by means of a 3D printing process. In addition or as an alternative to the electrical conductor 7, the diaphragm material 27 can also be printed by means of the 3D printing process.

The coil arrangement 4 also includes at least one contacting section 29, which electrically connects the conductor sections 8a-8j of the various conductor sections 5, 6 which, in particular, are arranged one above the other. Additionally or alternatively, the at least one contacting section 29 can also be printed by means of the 3D printing process.

The acoustic unit 1 shown here also has an insulating layer 28, which is arranged between the two conductor layers 5, 6 and/or electrically insulates the two conductor layers 5, 6 from one another. As a result, the conductor sections 8a, 8j of the respective conductor layers 5, 6 are electrically insulated from one another. The conductor sections 8a, 8j of the respective conductor layers 5, 6 are then electrically connected to one another merely by means of the at least one contacting section 29.

It is advantageous when the acoustic unit 1 has at least one protective layer 30, 31, as shown in this exemplary embodiment. By means of the at least one protective layer 30, 31, the electrical conductor 7, or the conductor sections 8a-8j, can be protected. Two protective layers 30, 31 are shown here, namely one protective layer 30, 31 on each of the two mutually opposite sides.

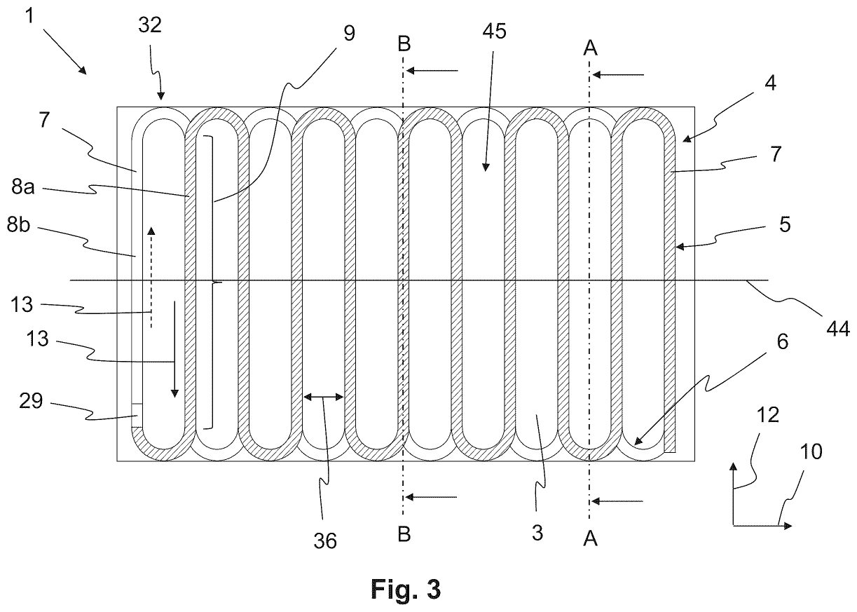

FIG. 3 shows a top view of a schematic view of an acoustic unit 1 having an electrical conductor 7. As is apparent here, the electrical conductor 7 is arranged in a meandering manner. The electrical conductor 7 meanders through the conductor layers 5, 6.

Moreover, the two conductor layers 5, 6 are shown in FIG. 3. The electrical conductor 7, which is shaded here, is arranged in the first conductor layer 5. The electrical conductor 7, which is not shaded here and is shown on the left side of the figure, is arranged in the second conductor layer 6. The second conductor layer 6 is arranged, for example, under the first conductor layer 5 in this viewing direction.

As an example, two conductor sections 8a, 8b are also provided with a reference character in FIG. 3. The first conductor section 8a is arranged here in the first conductor layer 5 and the second conductor section 8b is arranged in the second conductor layer 6.

Furthermore, the contacting section 29 is shown in FIG. 3 (at the bottom left in FIG. 3). Due to this contacting section 29, the electrical conductor 7 is routed from the first conductor layer 5 into the second conductor layer 6.

Furthermore, an overlap section 9 is shown in FIG. 3. As is apparent, the acoustic unit 1 has multiple overlap sections 9. For the sake of clarity, only one overlap section 9 is provided with a reference character.

In addition, the electric currents 13 are shown in FIG. 3 using the arrows. The solid arrow represents the electric current 13 in the first conductor layer 5, or in the first conductor section 8a shown in FIG. 3, and the dashed arrow represents the electric current 13 in the second conductor layer 5, or in the second conductor section 8b. The electric current 13 flows according to the solid arrow in the overlap section 9 in one direction, or in the longitudinal direction 12. After the contacting section 29, the electric current 13 flows according to the dashed arrow in the opposite direction, or in the longitudinal direction 12. Therefore, the electric current 13 flows in opposite directions in the two conductor sections 8a, 8b shown in FIG. 3.

After the electric current 13 has flowed through the second conductor section 8b, a connecting section 32 is encountered. The electrical conductor 7 includes the connecting section 32. The connecting section 32 connects two conductor sections 8 which are arranged next to one another, in particular in the transverse direction 10. The connecting section 32 shown in FIG. 3 connects the second conductor section 8b to the conductor section 8 which is not shown in FIG. 3 and which is arranged under the first conductor section 8a in the viewing direction. As a result, the electric current 13, once it has flown through the second conductor section 8b and the connecting section 32, can flow parallel to the electric current 13 in the first conductor section 8a.

In the present exemplary embodiment, the conductor sections 8 are straight and/or parallel to one another. Additionally or alternatively, two conductor sections 8 which are adjacent to one another, in particular in the transverse direction 10, are antiparallel to each other. This means, in two conductor sections 8 which are adjacent to one another, in particular in the transverse direction 10, the respective electric currents 13 are antiparallel to each other, or are oriented oppositely to one another.

Additionally or alternatively, the connecting sections 32 are curved. In particular, the connecting sections 32 are curved such that they reverse the current direction of the electric current 13. The connecting sections 32 therefore have a 180° curvature. The connecting sections 32 can form a semi-circle.

A conductor section spacing 36 is also shown here. The conductor section spacing 36 is the spacing between two conductor sections 8 of a conductor layer 5, 6. The conductor section spacing 36 is also the spacing between two adjacent overlap sections 9. The conductor section spacing 36 can advantageously correspond to a magnet element width 38, in particular 50% to 200% of the magnet element width 38. Moreover, the conductor sections 8 are concentrated in the region between two magnet elements 16-21 which are arranged consecutively in the transverse direction 10, or in the region of the open area 26. The coil arrangement 4 is formed in this manner. The magnet element width 38 is the width of the magnet elements 16-21 in the transverse direction 10. The magnet element width 38 is shown in FIG. 1.

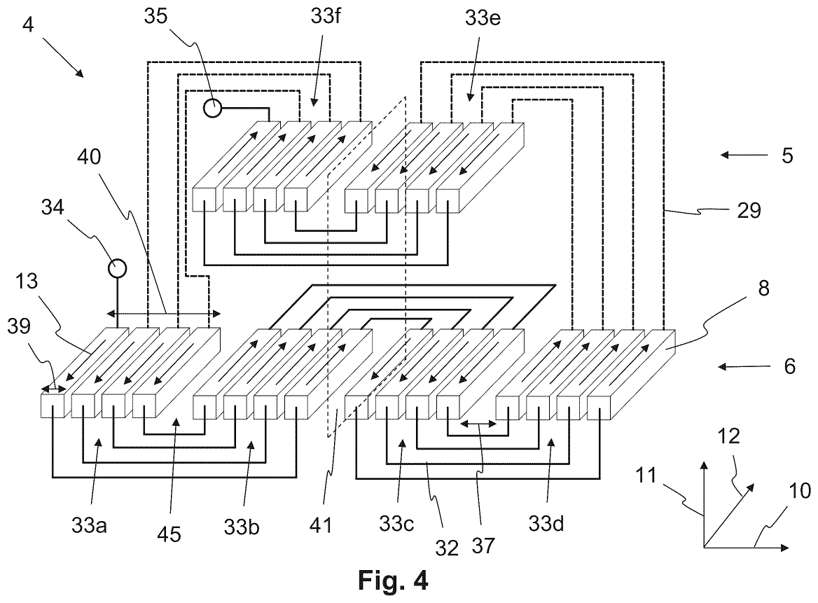

Furthermore, a second mirror plane 44 is shown in FIG. 3. The first mirror plane 41 is shown in FIG. 4. The second mirror plane 44 extends in the transverse direction 10 and in the normal direction 11. The electrical conductor 7 and/or the conductor sections 8 and/or the overlap sections 9 are mirrored at the second mirror plane 44. As is apparent here, the connecting sections 32 are mirrored at the second mirror plane 44 such that they switch the conductor layer 5, 6 when mirrored.

FIG. 4 shows a perspective view of an electrical conductor 7 in two conductor layers 5, 6 and with multiple conductor sections 8.

Multiple conductor sections 8 are shown in FIG. 4. For the sake of clarity, only one conductor section 8 is provided with a reference character.

Moreover, multiple conductor section groups 33a-33f are shown in FIG. 4. The conductor section groups 33a-33f each include multiple conductor sections 8, and these are grouped. This means, a conductor group spacing 37 between two conductor section groups 33a-33f is greater than or equal to a spacing, or a conductor section spacing 36, between two conductor sections 8 of a conductor section group 33a-33f. The conductor section spacing 36 between two adjacent conductor sections 8 is not shown here, for the sake of clarity. Moreover, according to the present exemplary embodiment, a conductor section group 33a-33f includes four conductor sections 8.

The conductor group spacing 37 is dimensioned such that a magnet element 16-21 can be arranged between two adjacent conductor section groups 33a-33f.

Moreover, it is advantageous when the electric current 13 flowing in the conductor sections 8 of a conductor section group 33a-33f is flowing in parallel and/or in the same direction in said conductor sections. This is shown by the arrows of the electric currents 13 of the conductor sections 8 of a conductor section group 33a-33f extending in parallel and/or in the same direction.

Furthermore, it is advantageous when the electric currents 13 in the conductor sections 8 of adjacent conductor section groups 33a-33f are oriented oppositely to one another. For example, the electric currents 13 of the first conductor section group 33a flow out of the plane in this perspective. The electric currents 13 of the second conductor section group 33b, which is adjacent thereto, are oriented in the opposite direction. This means, these electric currents 13 flow into the plane. The electric currents 13 of the conductor sections 8 of the third conductor section group 33c, which is adjacent thereto, are again oriented in the opposite direction.

Furthermore, some conductor section groups 33a-33f are arranged in the first conductor layer 5 and some conductor section groups 33a-33f are arranged in the second conductor layer 6. Four conductor section groups 33a33d are arranged in the second conductor layer 6 and two conductor section groups 33e-33f are arranged in the first conductor layer 5.

Since the first four conductor section groups 33a-33d are arranged in the second conductor layer 6 and the fifth and the sixth conductor section groups 33e-33f are arranged in the first conductor layer 5, these are connected to one another via the connecting sections 32. For the sake of clarity, only one connecting section 32 is provided with a reference character. The conductor sections 8 are connected to one another by means of the connecting sections 32 such that one conductor section 8 of a conductor section group 33a-33f is followed by a conductor section 8 of another conductor section group 33a-33f. The connecting sections 32 are shown here by means of solid lines.

In addition, contacting sections 29 are shown in this exemplary embodiment, which contacting sections 29 connect the conductor sections 8 of the various conductor layers 5, 6 to one another. The contacting sections 29 are each arranged between a conductor section 8 of the first conductor layer 5 and a conductor section 8 of the second conductor layer 6.

In addition, the electrical conductor 7 has an input 34 and output 35, and therefore the electric current 13 is conducted from the input 34 to the output 35. Moreover, only one single input 34 and one single output 35 are present. This means, one single electrical conductor 7 extends through the coil arrangement 4.

Moreover, the conductor section groups 33a-33f have conductor group widths 40. For the sake of simplicity, only one conductor section group 33b is labeled with the conductor group width 40.

With respect to FIG. 1, the conductor section width 39 can be greater than or equal to the spacing of two magnet elements 16-21 which are consecutive in the transverse direction 10. These two magnet elements 16-21 which are consecutive in the transverse direction 10 are, or can be, arranged in various magnet units 14-15. The same can also apply for the conductor section groups 33a-33f. The conductor section width 40 can be greater than or equal to the spacing of two magnet elements 16-21 which are consecutive in the transverse direction 10. These two magnet elements 16-21 which are consecutive in the transverse direction 10 are, or can be, arranged in various magnet units 14-15. The conductor section width 39 of the conductor section 8 of the conductor section group 33a-33f is correspondingly small, since multiple conductor sections 8 form the conductor section group 33a33f.

FIG. 4 also shows a first mirror plane 41. The second mirror plane 44 is shown in FIG. 3. The coil arrangement 4, the at least one electrical conductor 7, the conductor sections 8 and/or the conductor section groups 33a-33f have symmetry, in particular mirror symmetry. The coil arrangement 4, the at least one electrical conductor 7, the conductor sections 8 and/or the conductor section groups 33a-33f are mirrored at the first mirror plane 41. As is also apparent here, however, the electric currents 13 are mirrored such that they reverse the orientation when mirrored. This symmetry can apply, in particular, for the arrangement of the conductor sections 8 of the conductor section groups 33a-33f, the connecting sections 32 and/or the contacting sections 29. If, for example, a connecting section 32 has a sharp bend and its mirrored partner does not have a sharp bend, then this does not absolutely need to destroy the symmetry described here. Instead, the symmetry can mean that the at least one electrical conductor 7, the conductor sections 8, and/or the conductor section groups 33a-33f are arranged substantially symmetrically. A connecting section 32 and/or a contacting section 29 and the corresponding mirrored partners connect two connector sections 8 and the corresponding mirrored partners. The first mirror plane 41 extends in the normal direction 11 and in the longitudinal direction 12.

The acoustic unit 1, in particular the electrical conductor 7, the conductor sections 8, the overlap sections 9, the conductor section groups 33a-33f, the connecting sections 32, and/or the contacting sections 29, can have symmetry according to the first mirror plane 41 and/or the second mirror plane 44. The electrical conductor 7, the conductor sections 8, the overlap sections 9, the conductor section groups 33a-33f, the connecting sections 32, and/or the contacting sections 29 can be arranged in a mirrored manner such that they switch the conductor layer 5, 6 when mirrored at the first mirror plane 41 and/or at the second mirror plane 44.

Technical advantages are created as a result of the symmetry, such as, for example, a balanced force generation, balanced weight distribution and, as a result, an idealized vibration behavior. Moreover, repeated conductor passages between the magnets can be avoided.

FIG. 4 also shows the intermediate region 45 between two conductor section groups 33 which are adjacent to one another in the transverse direction 10.

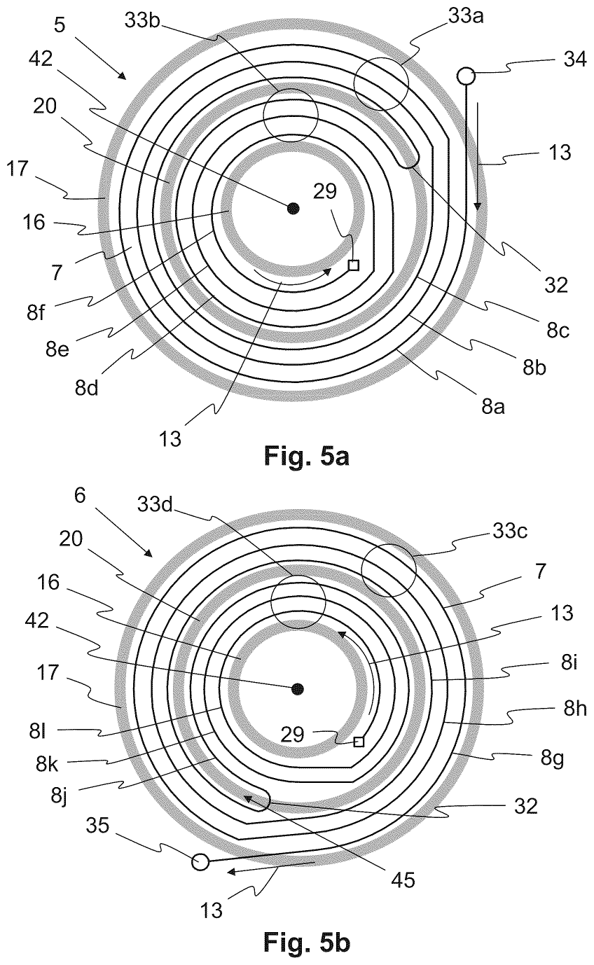

FIGS. 5a and 5b show top views of an acoustic unit 1 having a circular electrical conductor 7. FIG. 5a shows the first conductor layer 5 and the electrical conductor 7, including the curved conductor sections 8, arranged therein. FIG. 5b shows the second conductor layer 6 and the electrical conductor 7, including the curved conductor sections 8a-8f, arranged therein. The two conductor layers 5, 6 are arranged one above the other. In addition, the contacting section 29 which connects the conductor sections 8a-8f of the two conductor layers 5, 6 is shown in both FIGS. 5a, 5b.

Furthermore, three magnet elements 16, 17, 20 are shown in this example from FIGS. 5a, 5b. The radial innermost magnet element 16 shown in FIGS. 5a, 5b and the radial outermost magnet element 17 are, for example, part of the first magnet unit 14 (cf. FIG. 1). The magnet element 20 arranged between these two magnet elements 16, 17 is part of the second magnet unit 15 (cf. FIG. 1). In comparison with the two magnet units 14, 15 from FIG. 1, the magnet elements 16, 17, 20 shown in FIGS. 5a, 5b are not straight, but rather likewise curved, or circular. The outermost magnet element 17 shown in FIGS. 5a, 5b is arranged in the radial direction outside the first conductor section group 33a from FIG. 5a and the third conductor section group 33c from FIG. 5b. The innermost magnet element 16 shown in FIGS. 5a, 5b is arranged in the radial direction inside the conductor section group 33b from FIG. 5a and the fourth conductor section group 33d from FIG. 5b. The magnet element 20 shown in FIGS. 5a, 5b in the middle in the radial direction is arranged, in FIG. 5a, between the first and the second conductor section groups 33a, 33b and, in FIG. 5b, between the third and the fourth conductor section groups 33c, 33d.

In addition, six conductor sections 8a-8f are shown in FIG. 5a. The conductor sections 8a-8f are spaced apart from one another in a radial direction. Six conductor sections 8g-81 are shown in FIG. 5b. The conductor sections 8a-8f shown in FIG. 5a overlap with the conductor sections 8g81 shown in FIG. 5b, such that the overlap sections 9 (not shown here) are formed.

The electric current 13 is oriented in FIGS. 5a and 5b such that it flows in a radial direction from the outside to the inside in FIG. 5a and from the inside to the outside in FIG. 5b.

Moreover, in FIG. 5a, the three outer conductor sections 8a-8c are combined to form the first conductor section group 33a. The three inner conductor sections 8d-8f are combined to form the second conductor section group 33b. The magnet element 20 is arranged in the sound transducer unit 2 between the first conductor section group 33a and the second conductor section group 33b. The two conductor section groups 33a, 33b are connected here to the connecting section 32. As is also apparent here, the electric currents 13 in the respective conductor sections 8a-8f of the respective conductor section groups 33a, 33b flow in parallel with one another. Therefore, the electric current 13 flows in opposite directions in the two conductor sections 8a, 8b shown in FIG. 5a.

The same applies for FIG. 5b as for FIG. 5a. The three outer conductor sections 8g-8i are combined to form the third conductor section group 33c. In this conductor section group 33c, the electric currents 13 in the conductor sections 8g-8i flow in parallel with one another. The three inner conductor sections 8j-81 are combined to form the fourth conductor section group 33d. Therein as well, the electric currents 13 in the conductor sections 8j-81 flow in parallel with one another.

The electric currents 13 in the conductor sections 8g-81 of the adjacent conductor section group 33c, 33d, however, flow oppositely to one another.

The electrical conductor 7, the conductor sections 8, and/or the conductor section groups 33a-33d also have symmetry, in particular point symmetry, in FIGS. 5a and 5b. For this purpose, a center of symmetry 42 is shown, which is arranged in the middle of the conductor layers 5, 6. The symmetry is to be understood here as being fundamental. For example, the slight sharp bends on the right side in FIG. 5a and the sharp bends in the lower region in FIG. 5b destroy the symmetry. In addition, the connecting sections 32 of the respective figures also do not have a symmetry partner. However, it is understood that at least the conductor sections 8 are symmetrically arranged, i.e., each conductor section 8 has a symmetry partner with respect to the center of symmetry 42. The advantages of the symmetry are mentioned with respect to FIG. 4.

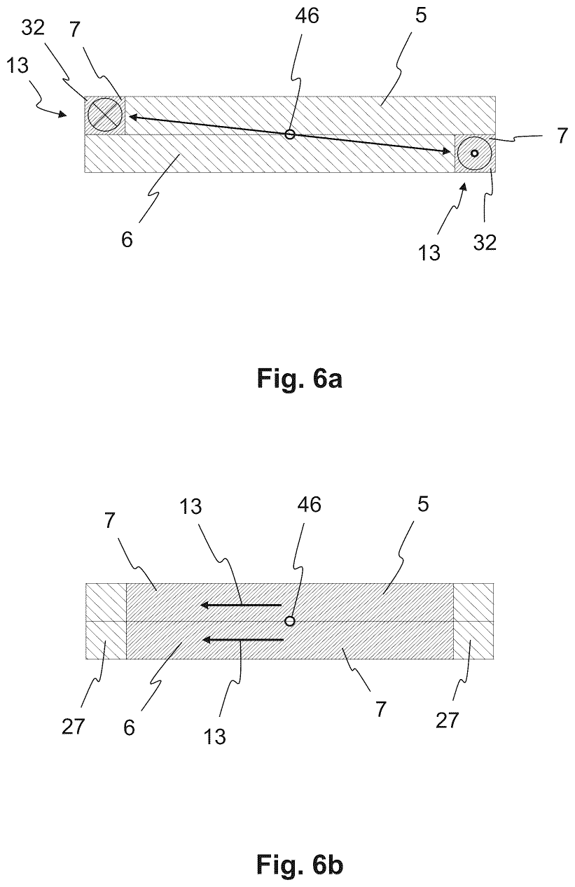

FIGS. 6a and 6b show two sectional views of FIG. 3 according to the sections A-A and B-B. FIG. 6a shows the section A-A and FIG. 6b shows the section B-B.

As is apparent, a mirror line 46 is drawn. Along the mirror line 46, the connecting sections 32 have mirror symmetry, as is apparent in FIG. 6a in combination with FIG. 3. The mirroring is indicated by the arrow. The connecting section 32 of the first conductor layer 5 (upper left) is mirrored onto the connecting section 32 of the second conductor layer 6 (lower right), and vice versa. The electrical conductor 7 is arranged, formed, and/or installed such that, when the connecting sections 32 are mirrored at the mirror line 46, the current directions of the electric current 13 flowing in the connecting sections 32 reverse. This results in an advantageous installation, or arrangement, of the electrical conductor 7. Due to the mirror symmetry of the connecting sections 32 at the mirror line 46, the electric currents 13 in the conductor sections 8 having the overlap sections 9 are parallel with one another. Moreover, due to the mirror symmetry of the connecting sections 32 at the mirror line 46, long distances of the electrical conductor 7 outside the conductor sections 8 in the overlap sections 9 are prevented. This results in a mechanical balance and in a conductor length of the electrical conductor 7 outside the relevant permanent magnetic field 23 that is as short as possible.

The mirror symmetry of the connecting sections 32 at the mirror line 46 can be geometric mirroring, or mirror symmetry, and/or functional mirroring, or mirror symmetry. In geometric mirroring, shapes of the connecting sections 32 are retained. Additionally or alternatively, the sizes and/or dimensions of the connecting sections 32 can also be retained. The geometric mirroring is apparent in FIG. 3, in which the shape and/or the size of the connecting sections 32 are retained. Both connecting sections 32 are curved, or circular, i.e., they have the same shape.

Additionally or alternatively, the connecting sections 32 can also have functional mirroring, or mirror symmetry. In functional mirroring, the function and the purpose of the connecting sections 32 are retained. The shape and/or the size can change. For example, the connecting sections 32 shown in FIG. 3, which together have functional mirror symmetry, can have different shapes and/or sizes. For example, as is shown in FIG. 3, one connecting section 32 can be curved, or circular, and the associated mirrored connecting section 32 can be angular. The shape and/or size are not important for the function and/or the purpose of the connecting sections 32, since these connect the conductor sections 8 in the overlap sections 9.

However, it can be advantageous when the connecting sections 32 have, in particular substantially or approximately, geometric mirror symmetry. This results in a uniform and/or mirrored weight distribution of the electrical conductor 7, which results in improved deflection properties. Therefore, deviations from the geometric mirroring, or mirror symmetry, are permitted, provided they do not negatively affect the vibrational properties of the acoustic unit 1, due to the asymmetric weight distribution, or provided that the changed vibrational property is tolerable.

Moreover, the connecting sections 32 cross over the intermediate regions 45 and/or bridge these. The magnet elements 16-21 are also arranged in the intermediate regions 45, as is apparent in FIG. 1. Only one or more magnet element(s) 16-21 is/are arranged in each of the intermediate regions 45. Consequently, the connecting sections 32 cross over the magnet elements 16-21 when the acoustic unit 1 is arranged in the sound transducer unit 2 as intended.

Alternatively, the connecting sections 32 can project in the longitudinal direction 12 beyond the magnet elements 16-21. There, the permanent magnetic field 23 weakens, and therefore the electric current 13 in the connecting sections 32 only barely interacts with the permanent magnetic field 23.

In this exemplary embodiment and, better, in FIG. 3, it is shown that one, in particular only one, connecting section 32 crosses over the intermediate region and/or bridges this in each conductor layer 5, 6.

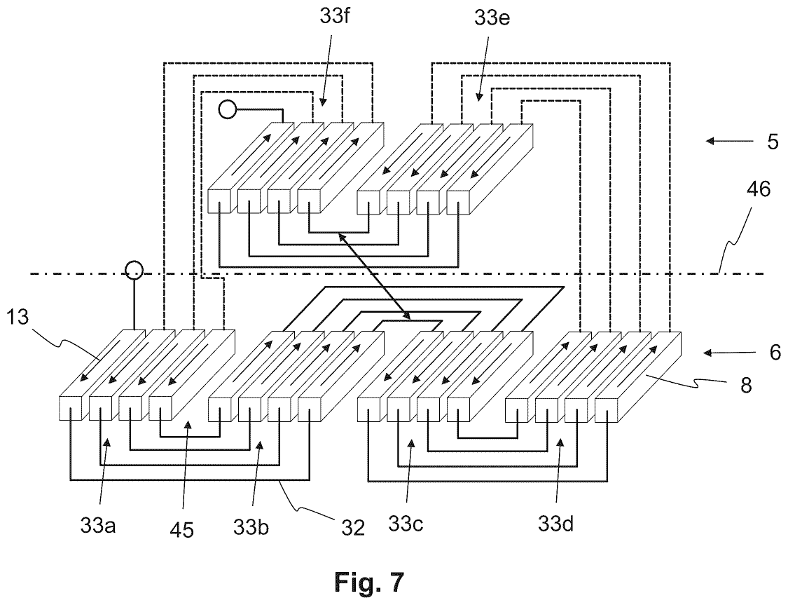

FIG. 7 shows the arrangement of the coil arrangement 4 from FIG. 4. All non-relevant reference characters have been omitted here in order to better illustrate the mirror symmetry. The mirror line 46 is shown here again. In addition, the mirroring is shown by way of example at two connecting sections 32 by means of arrows. The connecting section 32 in the first conductor layer is mirrored onto the connecting section 32 in the second conductor layer 6, and the current direction is reversed in the mirroring. It is to be noted here that the connecting sections 32 of the upper first conductor layer 5 are merely schematically shown as if they are bent downward in the direction of the second conductor layer 6. In reality, they are arranged such that they extend in a plane with the first conductor layer 5. The same also applies for the connecting sections 32 of the second conductor layer 6, which are also shown here as if they extend downward.

Moreover, the mirror symmetry of the connecting sections 32 at the mirror line 46 applies only for the connecting sections 32 which also have a mirror partner. In FIGS. 4 and 7, for example, the connecting sections 32 of the two outer pairs of conductor section groups 33a, 33b and 33c, 33d do not have a mirror partner in the first conductor layer 5. The coil arrangements 4 can have multiple shown conductor sections 8, however, as is shown in FIGS. 4 and 7. Consequently, at least most of the connecting sections 32 can have a mirror partner.

Moreover, the intermediate regions 45 between the conductor section groups 33 are shown in FIG. 7. Only one intermediate region 45 is provided with a reference character. As is also apparent here, multiple connecting sections 32 cross over and/or bridge an intermediate region 45. Moreover, the connecting sections 32 are arranged in parallel with one another when these multiple connecting sections 32 cross over and/or bridge an intermediate region 45. As a result, the connecting sections 32 are prevented from crossing over themselves when they cross over and/or bridge the intermediate region 45.

The conductor routing of the electrical conductor 7 is also apparent in FIGS. 4 and 7. According to this exemplary embodiment, the electrical conductor 7 is arranged such that the electric current 13 flows through a conductor section 8 of a conductor section group 33 and then through a conductor section 8 of another conductor section group 33. In this way, electric current 13 will flow through only one conductor section 8 per conductor section group 33 until the electric current 13 has flowed through all conductor section groups 33. The electric current 13 then flows through the next conductor section 8 of the first conductor section group 33a until the electric current 13 has flowed through all conductor section groups 33 again. This results in an advantageous and space-saving arrangement of the electrical conductor 7.

### LIST OF REFERENCE CHARACTERS

1 acoustic unit
2 sound transducer unit
3 diaphragm
4 coil arrangement
5 first conductor layer
6 second conductor layer
7 electrical conductor
8 conductor section
9 overlap section
10 transverse direction
11 normal direction
12 longitudinal direction
13 electric current
14 first magnet unit
15 second magnet unit
16 first magnet element
17 second magnet element
18 third magnet element
19 fourth magnet element
20 fifth magnet element
21 sixth magnet element
22 magnetizing direction
23 permanent magnetic field
24 conductor section spacing
25 stroke axis
26 open area
27 diaphragm material
28 insulating layer
29 contacting section
30 first protective layer
31 second protective layer
32 connecting section
33 conductor section group
34 input
35 output
36 conductor section spacing
37 conductor group spacing
38 magnet element width
39 conductor section width
40 conductor group width
41 first mirror plane
42 center of symmetry
43 magnet element spacing
44 second mirror plane
45 intermediate region
46 mirror line

1-29. (canceled)

30. An acoustic unit for a sound transducer unit for generating and/or detecting sound waves, the acoustic unit comprising:
a diaphragm; and
a coil arrangement coupled to the diaphragm, the coil arrangement having at least one electrical conductor, wherein the at least one electrical conductor has conductor sections at least in a first conductor layer and a second conductor layer of the at least one electrical conductor,
wherein:
the first and second conductor layers are arranged one above the other; and
at least one conductor section of the first conductor layer shares an overlap portion with at least one conductor section of the second conductor layer in which the at least one conductor sections of the first and second conductor layers overlap.

31. The acoustic unit of claim 30, wherein:
the conductor sections overlap in a transverse direction of the coil arrangement and/or in longitudinal direction of the coil arrangement, and/or
the overlap portion extends in the transverse direction and/or in the longitudinal direction of the coil arrangement.

32. The acoustic unit of claim 30, wherein at least two of the conductor sections arranged in at least one of the first conductor layer or the second conductor layer together form a conductor section group.

33. The acoustic unit of claim 32, wherein:
a conductor section spacing and/or a conductor group spacing between two adjacent conductor sections and/or conductor section groups is less than 1 mm; and/or
the conductor section spacing and/or the conductor group spacing is equal to or less than a magnet element width of a magnet element of the sound transducer unit.

34. The acoustic unit of claim 32, wherein:
a conductor section width of the conductor sections and/or a conductor group width of the conductor section group in a transverse direction of the coil arrangement is equal to or greater than an intended magnet element spacing between two magnet elements of the sound transducer unit; and/or
a width of an open area in the transverse direction between two magnet elements of the sound transducer unit that are arranged directly consecutively in the transverse direction.

35. The acoustic unit of claim 30, wherein the at least one electrical conductor is arranged such that the conductor sections are arranged in series to one another.

36. The acoustic unit of claim 30, wherein the at least one electrical conductor is arranged such that electric current flowing therein is conductable alternatingly in the first and second conductor layers.

37. The acoustic unit of claim 30, wherein multiple conductor sections and/or conductor section groups are adjacently arranged in at least one of the first conductor layer or the second conductor layer, and the at least one electrical conductor is arranged such that a current direction is alternatingly oriented in opposite directions in the adjacently arranged conductor sections and/or conductor section groups.

38. The acoustic unit of claim 30, wherein the at least one electrical conductor is arranged in a meandering manner.

39. The acoustic unit of claim 30, wherein between two and ten overlap portions are adjacently arranged in a transverse direction of the coil arrangement.

40. The acoustic unit of claim 30, wherein the conductor sections of at least one of the first conductor layer or the second conduct layer form a conductor section group, and the at least one electrical conductor is arranged such that electric currents flowing in the conductor sections of the conductor section group are oriented in parallel with one another and/or in the same direction.

41. The acoustic unit of claim 30, wherein the at least one electrical conductor is arranged such that electric currents of the conductor sections of two adjacent conductor section groups are oriented antiparallel to each other and/or in opposite directions.

42. The acoustic unit of claim 30, wherein the at least one electrical conductor has multiple connecting sections which electrically connect the conductor sections of the first and second conductor layers to each other and wherein the multiple connecting sections have mirror symmetry at a mirror line so that a connecting section of the first conductor layer is mirrored onto a connecting section of the second conductor layer, wherein a current direction, when mirrored, reverses in the mirrored connecting sections of the first and second conductor layers.

43. The acoustic unit of claim 30, wherein the at least one electrical conductor has multiple connecting sections which electrically connect the conductor sections of the first and second conductor layers to each other and wherein:
the multiple connecting sections cross over intermediate regions of the conductor sections; and/or
the multiple connecting sections cross over magnet elements of a magnet unit of the sound transducer unit when the acoustic unit is arranged in the sound transducer unit.

44. The acoustic unit of claim 30, wherein the at least one electrical conductor and/or the conductor sections have symmetry with respect to a mirror plane and/or a center of symmetry.

45. The acoustic unit of claim 30, wherein:
the at least one electrical conductor is printed using a 3D printing process; and/or
the coil arrangement is formed by using a lithography process.

46. The acoustic unit of claim 30, wherein:
the coil arrangement is resistant to deformation; and/or
the coil arrangement and/or at least one of the first conductor layer or the second conductor layer are/is formed from silicon substrate.

47. The acoustic unit of claim 30, wherein:
the coil arrangement is connected to the diaphragm and/or the at least one electrical conductor is formed with the diaphragm; and/or
the coil arrangement is embedded into the diaphragm and/or is surrounded by the diaphragm material.

48. A sound transducer unit for generating and/or detecting sound waves, the sound transducer unit comprising:
at least one magnet unit including multiple magnet elements; and
at least one acoustic unit configured in accordance with claim 30.

49. A coil arrangement for an acoustic unit configured in accordance with claim 30.
